(19) United States
(12) Patent Application Publication
(10) Pub. No.: US 2007/0033408 A1
(43) Pub. Date: Feb. 8, 2007

(54) PREVENTING ILLEGAL DISTRIBUTION OF COPY PROTECTED CONTENT

(75) Inventor: Glenn A. Morten, Bellevue, WA (US)

Correspondence Address: DARBY & DARBY P.C., P. O. BOX 5257, NEW YORK, NY, 10150-5257, US

(73) Assignee: Widevine Technologies, Inc., Seattle, WA (US)

(21) Appl. No.: 11/462,323

(22) Filed: Aug. 3, 2006

Related U.S. Application Data
(60) Provisional application No. 60/706,492, filed on Aug. 8, 2005.

(51) Int. Cl. H04L 9/00

(52) U.S. Cl. 713/176

(57) ABSTRACT

Method and devices are directed to invention is directed towards analyzing packets on-the-fly for pirated content. Packets are intercepted and analyzed to determine if the packets include media content. If media content is detected, a comparator determines a fingerprint associated with the media content. The comparator then compares the determined fingerprint to other fingerprints within a data store. If a match is found, forensic information may be collected. Piracy detection responses may also be performed, including: blocking transmission of the media content, providing a piracy alert message, degrading a quality of the media content, or including within the media content a watermark and/or fingerprint. In one embodiment, the packet analysis and the comparator may reside within a same or different device within a path between a source device and a destination device to enable piracy detection to be performed in real-time.

### CROSS-REFERENCE TO RELATED APPLICATIONS

The present application claims benefit of provisional application Ser. No. 60/706,492 entitled “Method To Prevent Illegal Distribution Of Copy Protected Content,” filed on Aug. 8, 2005, the benefit of the earlier filing date of which is hereby claimed under 35 U.S.C. § 119 (e) and 37 C.F.R. §1.78, and which is further incorporated by reference.

### FIELD OF THE INVENTION

The present invention relates generally to digital copy protection and more particularly, but not exclusively, to employing unique identifiers to detect and/or deter illegal distribution of selected digital content.

### BACKGROUND OF THE INVENTION

Recent advances in the telecommunications and electronics industry, and, in particular, improvements in digital compression techniques, networking, and hard drive capacities have led to growth in new digital services to a user's home. For example, such advances have provided hundreds of cable television channels to users by compressing digital data and digital video, transmitting the compressed digital signals over conventional coaxial cable television channels, and then decompressing the signals in the user's receiver. One application for these technologies that has received considerable attention recently includes video-on-demand (VOD) systems where a user communicates with a service operator to request content and the requested content is routed to the user's home for enjoyment. The service operator typically obtains the content from an upstream content provider, such as a content aggregator or distributor. The content aggregators, in this market stream, in turn, may have obtained the content from one or more content owners, such as movie studios. Such content may then be provided to an end-user, whom may attempt to copy or even redistribute the content

While the video-on-demand market stream provides new opportunity for profits to content owners, it also creates a tremendous risk for piracy of the content. Such risk for piracy may arise at any place in the market stream that the content is exposed. For example, such piracy may arise when the end-user attempts to redistribute the content to another end-user improperly. Without appropriate protection, the content can be illicitly copied, and redistributed, thus depriving content owners of their profits.

Furthermore, the content owner is often unable to determine where in the market stream the content was used in an unauthorized manner. Without a way of determining where a security breach arose, the content owner may be unable to take appropriate action to minimize further piracy. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Descriptions, which is to be read in association with the accompanying drawings, wherein:

FIG. 1 shows a functional block diagram illustrating one embodiment of an environment for practicing the invention;

FIG. 2 shows a block diagram that illustrates one embodiment of a terminal device configuration;

FIG. 3 shows a block diagram that illustrates one embodiment of components for practicing the invention;

FIG. 4 shows one embodiment of a device that may be employed to provide real-time copy detection;

FIG. 5 illustrates a flow diagram generally showing one embodiment of a process of managing real-time copy detection; and

FIG. 6 illustrates a flow diagram generally showing another embodiment of a process of managing real-time copy detection, in accordance with various embodiments.

### DETAILED DESCRIPTION OF THE INVENTION

The present invention now will be described more fully hereinafter “with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the present invention is directed towards analyzing packets on-the-fly for pirated content. A flow of packets may be intercepted and analyzed to determine if the packets include media content. If not, the packets may be forwarded towards their destination. However, if media content is detected in the flow of packets, the packets may be further analyzed. In one embodiment, the packets are redirected to another processor, or device that may include at least a comparator. The comparator determines a fingerprint associated with the media content. In one embodiment, the fingerprint is determined by extracting information from the media content. The comparator then compares the determined fingerprint to other fingerprints. In one embodiment, the other fingerprints may be stored in a data store. In another embodiment, at least one other fingerprint may be provided in-band with the media content, or through an out-of-band mechanism to the sending of the media content. In one embodiment, the comparator may also determine a watermark from the media content, and perform a comparison of to watermarks in a data store. In any case, if a match is found to the determined fingerprint and/or watermark, forensic information may be collected from the media content and/or the network packet. Such forensic information may include a packet destination address (or other identifier), a packet source address (or other identifier), media content identifier, media content owner, time information, or the like. In addition, at least one of a variety of possible piracy detection responses may be performed, including: blocking transmission of the media content towards the destination, providing a piracy alert message, degrading a quality of the media content and allowing the degraded media content to be transmitted to the destination, including within the media content a watermark and/or fingerprint, or the like. In one embodiment, the included watermark/fingerprint may be visible to a ‘naked eye,’ while in another embodiment, the watermark/fingerprint may be invisible. In one embodiment, both visible and invisible watermarks and/or fingerprints may be included within the media content. In one embodiment, the included watermark and/or fingerprint may incorporate at least some of the forensic information.

In one embodiment, the packet analysis and the comparator may reside on one or more processors. The processors may reside within a same or different network device, including a personal computer, a set-top-box, a personal video recorder, a network video recorder, a network switch, a modem, a gateway, or virtually any other device within a path between and including a source terminal device and a destination terminal device. By implementing the processors within one or more devices within a media stream, the analysis and comparisons for may be performed in real-time as packets are received by the terminal devices. This further enables embodiments to detect piracy or attempts to pirate media content on-the-fly.

Illustrative Environment

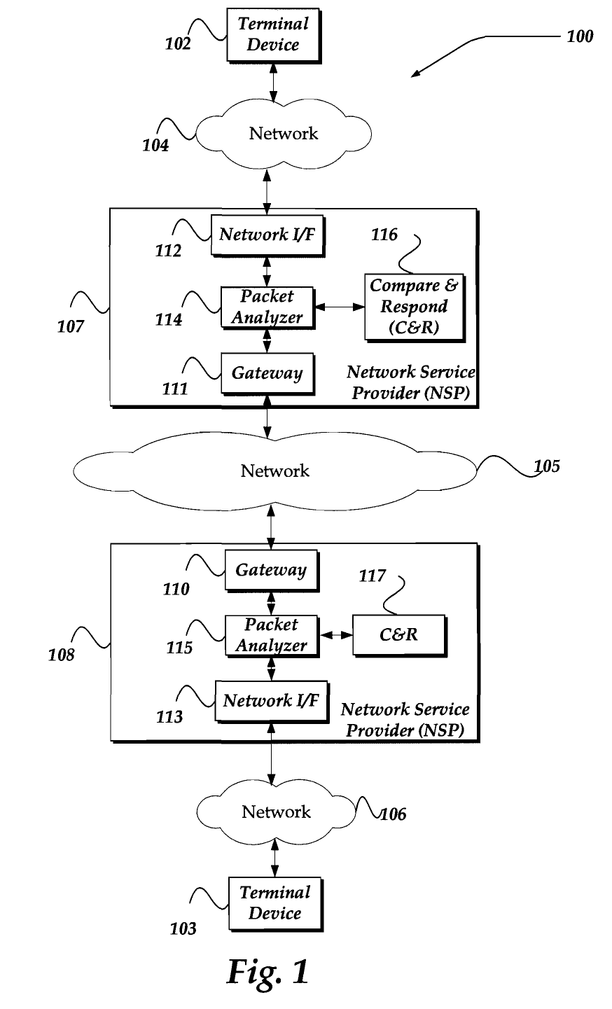

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes terminal devices 102-103, networks 104-106, and Network Service Providers (NSP) 107-108. NSP 107 includes network interface (I/F) 112, packet analyzer 114, compare & respond (C&R) 116, and gateway 111. Similarly, NSP 108 includes network interface (I/F) 113, packet analyzer 115, compare & respond (C&R) 117, and gateway 110.

Terminal device 102 is in communications with NSP 107 through network 104, while terminal device 103 is in communications with NSP 108 through network 106. NSPs 107 and 108 are in communication with each other through network 105.

Generally, terminal devices 102-103 may include virtually any computing device capable of connecting to another computing device to send and receive information, including media content over networks 104 and/or 106. Terminal devices 102-103 may also send and/or receive media content employing other mechanisms besides networks 104 and 106, including, but not limited to CDs, DVDs, tape, electronic memory devices, or the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device, and the like. Similarly, terminal devices 102-103 may be any device that is capable of connecting using a wired or wireless communication medium such as a PDA, POCKET PC, wearable computer, and any other device that is equipped to communicate over a wired and/or wireless communication medium. Similarly, terminal devices 102-103 may employ any of a variety of other devices to receive and enjoy such media content, including, but not limited to, a computer display system, an audio system, a jukebox, set top box (STB), a television, video display device, or the like.

Such media content includes, but is not limited to motion pictures, movies, videos, music, PPV, VoD, interactive media, audios, still images, text, graphics, and other forms of digital content. A network device may provide the media content using any of a variety of mechanisms. In one embodiment, the media content is provided as a Moving Pictures Experts Group (MPEG) content stream, such as a transport stream, program stream, or the like. Briefly, MPEG is an encoding and compression standard for digital broadcast content. MPEG provides compression support for television quality transmission of video broadcast content. Moreover, MPEG provides for compressed audio, control, and even user broadcast content. One embodiment of MPEG-2 standards is described in ISO/IEC 13818-7, which is available through the International Organization for Standardization (ISO), and which is hereby incorporated by reference.

Briefly, MPEG content streams may include Packetized Elementary Streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possible including independent time bases. Moreover, MPEG frames may include intra-frames (I-frames), forward predicted frames (P-frames), and/or bi-directional predicted frames (B-frames).

However, the invention is not so limited to MPEG media content formats, and other media content formats may also be employed, without departing from the scope or spirit of the invention.

In one embodiment, at least some of the media content may be restricted with respect to its distribution. For example, some media content may be restricted from multiple viewings by a recipient, from copying and/or redistributing the media content over the network, or the like. Moreover, in one embodiment, the media content may include information indicating rights or entitlements of use of the media content. For example, in one embodiment, the media content may be distributed with an Entitlement Management Message (EMM).

However, other mechanisms may also be employed for managing content protection. For example, such media content formats recently approved by the Federal Communications Commission (FCC) for redistribution control and content protection may also be used, including MagicGate Type R for Secure Video Recording for HI-MD Hardware; MagicGate Type R for Secure Video Recording for Memory Stick PRO Software; MagicGate Type R for Secure Video Recording for HI-MD Software; MagicGate Type R for Secure Video Recording for Memory Stick PRO Hardware; Smartright; Vidi Recordable DVD Protection System; High Bandwidth Digital Content Protection; Content Protection Recordable Media For Video Content; TivoGuard Digital Output Protection Technology; Digital Transmission Content Protection; Helix DRM Trusted Recorder; Windows Media Digital Rights Management; and D-VHS.

As used herein, the term “entitlement” refers to a right to access and use content. Typically, an entitlement may include a constraint on when the content may be accessed, how long it may be accessed, how often the content may be accessed, whether the content may be distributed, reproduced, modified, sold, or the like. In some instances, an entitlement may restrict where the content may be accessed as well.

Networks 104-106 are configured to couple network device, with each other, to enable them to communicate. In one embodiment, networks 104 and 106 represent private networks, such as might be owned, and/or managed, through network service providers such as NSPs 107-108, while network 105 might represent a public network and/or a network comprising public and private networks. Thus, in one embodiment, network 105 might represent the Internet. However, the invention is not so constrained, and other configurations may also be employed.

Networks 104-106 are enabled to employ any form of computer readable media for communicating information from one electronic device to another. Also, networks 104-106 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Networks 104-106 may further employ a plurality of wireless access technologies including, but not limited to, 2nd (2G), 3rd (3G), 4th (4G) generation radio access for cellular systems, Wireless-LAN, Wireless Router (WR) mesh, and the like. Access technologies such as 2G, 3G, 4G, and future access networks may enable wide area coverage for mobile terminal devices with various degrees of mobility. For example, networks 104-106 may enable a radio connection through a radio network access such as Global System for Mobil communication (GSM), General Packet Radio Services (GPRS), Enhanced Data GSM Environment (EDGE), Wideband Code Division Multiple Access (WCDMA), Code Division Multiple Access 2000 (CDMA 2000) and the like.

Furthermore, remote computers and other related electronic devices could be remotely connected to either LANs or WANs via a modem and temporary telephone link. In essence, networks 104-106 includes any communication method by which information may travel between various network devices.

Additionally, networks 104-106 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

NSPs 107-108 represent functional diagrams of one embodiment of a network service provider's infrastructure. NSPs 107-108 may include more or less components than are shown. The components shown however, are sufficient to disclose an illustrative embodiment for providing communications between a terminal device and a public/private network such as the Internet, or the like. As shown, network I/Fs 112-113 may represent any of a variety of network devices that enable connection into an NSP, including a bridge, gateway, router, firewall, network switch, or the like.

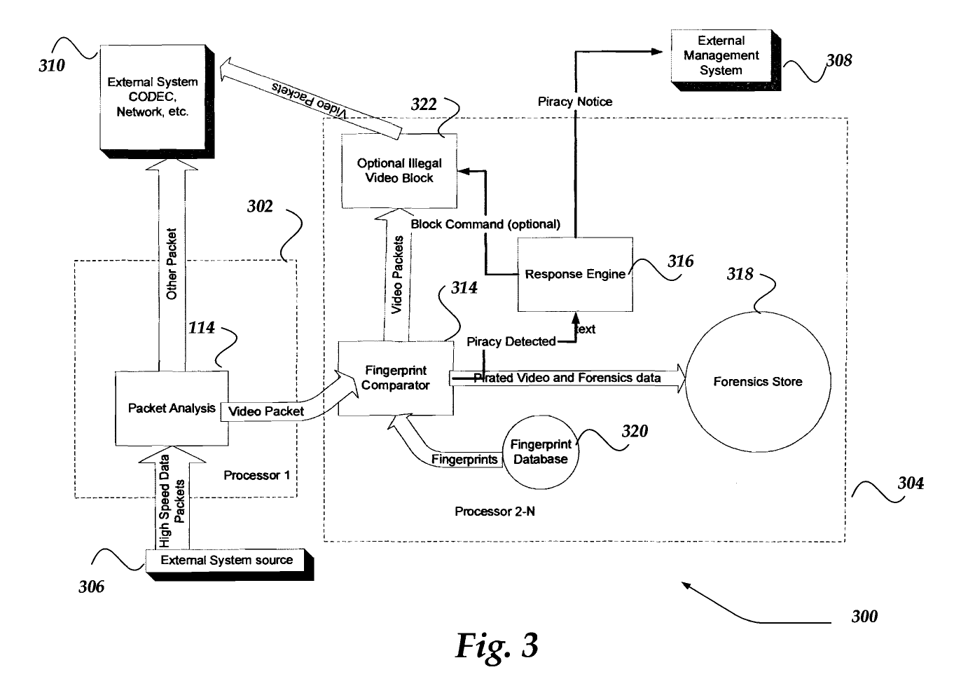

Packet analyzers 114-115 and C&Rs 116-117 are described in more detail below in conjunction with FIG. 3. Briefly, however packet analyzers 114-115 are configured to intercept network packets on a network, analyze the network packet's contents, and direct the flow of the packets based on its contents. C&Rs 116-117 may receive packets that include media content from packet analyzers 114-115 and perform piracy detection comparisons and responses. C&Rs 116-117 may employ various fingerprint and/or watermark techniques to perform comparisons to determine whether the media content may be distributed over the network or whether it's distribution is unauthorized and therefore, an attempt to pirate the media content.

Fingerprinting and/or watermarking techniques can be used to uniquely identify various media content. Briefly, a fingerprint may be a representation of various characteristics of the media content that is directed towards uniquely identifying one media content file from other media content file, at least within a particular statistical level of confidence. For example, a fingerprint may be generated based on such characteristics of the media content including, but not limited to, a word count within the media content, where a word may be a grouping of binary data within the media content. A fingerprint may also be determined based on a pixel characteristic, a frequency characteristic, image vectors, or the like, using any of a variety of algorithms, including an up-down algorithm, warp grids, a word count algorithm, or the like, such as described in U.S. Pat. No. 7,043,473 to Reza Rassool et al, entitled “Media tracking system and method,” and incorporated herein by reference.

However, the invention is not constrained to these fingerprint algorithms and virtually any fingerprint generation technique may be employed. Moreover, in one embodiment, a fingerprint may be uniquely generated based on a variety of characteristics external to the media content, such as a generation date of the media content, an owner of the media content, a serial number assigned to the media content and the like. The fingerprint may then be embedded in the media content substantially like a watermark (in this case a fingerprint will sometimes be referred to as a watermark) but it can also just be attached to the content, unlike a watermark. Moreover, watermarks and fingerprints may be invisible to the casual observer, further facilitating the claim of ownership, receipt of copyright revenues, or the success of prosecution for unauthorized use of the content. Typically, content is both watermarked and fingerprinted to uniquely identify the distribution path and points of the content in a market stream.

Briefly, a watermark is a digital signal or pattern that is inserted into content such as a digital image, audio, video content, and the like. Because the inserted digital signal or pattern is not present in unaltered copies of the original content, the digital watermark may serve as a type of digital signature for the copied content. For example, watermarking may be employed to embed copyright notices into the content. A given watermark may be unique to each copy of the content so as to identify the intended recipient, or be common to multiple copies of the content such that the content source may be identified. An example of fingerprinting/watermarking techniques is preprocessing content, which involves storing potential replacement frames of selected streaming media data files for later substitution. Content to be watermarked may be scanned and selected frames are extracted. Each extracted frame may be provided with a portion of a serial number, such as a single digit. The serial number may represent a unique identifier of a document source, or an intended recipient. The portion of the serial number may be located in several frames. When a particular content is provided, the selected watermarked frames are employed to replace the unmarked frames in the original content. Another example of fingerprinting/watermarking techniques is dynamic content modification, which decompresses, modifies, and recompresses content data packets. The modified data packets are sent over the network, rather than the original content data packets. A further example of fingerprinting/watermarking techniques is dark frame replacement employs knowledge that many video content includes black frames. Black frames may be stored with watermarks identifying the source of the content. Black frames may also be watermarked with a unique identifier. The watermarked black frames are employed to replace selected black frames on the fly as the content is transmitted to another computing device.

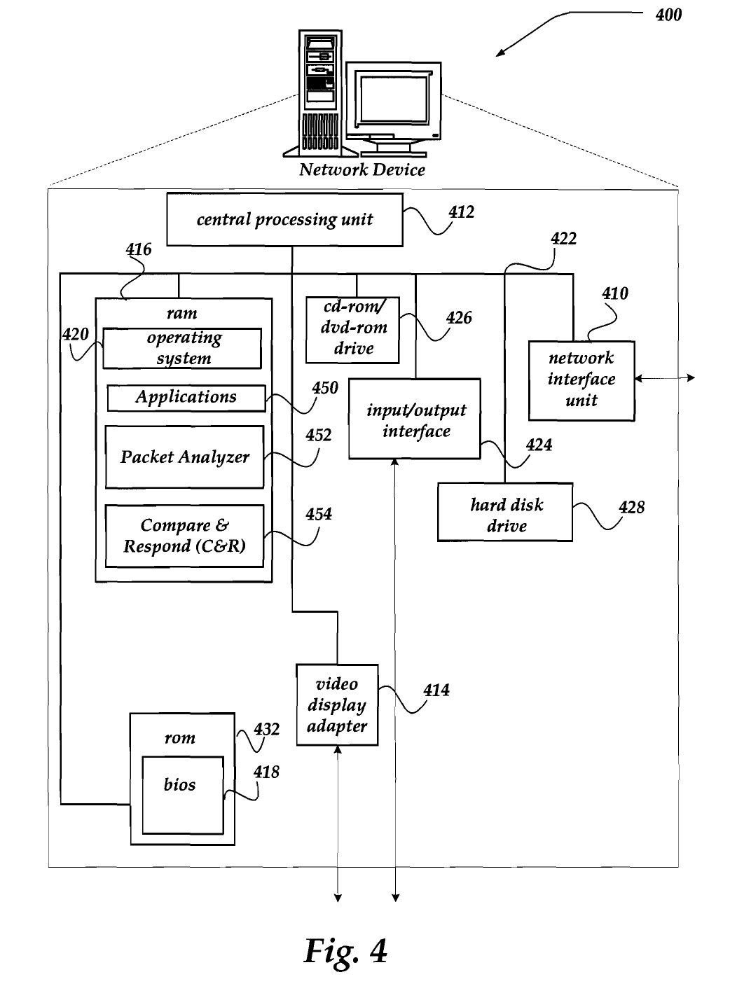

Although illustrated separately, packet analyzer 114 and C&R 116 (and/or packet analyzer 115 and C&R 117) may be deployed within one or more computing devices. For example, in one embodiment, packet analyzer 114 and C&R 116 may reside on distinct processors, or even within distinct network devices. In one embodiment C&R 116 may be distributed over several (2-N) distinct processors and/or network devices. Moreover, although packet analyzers 114-115 and C&Rs 116-117 are illustrated within NSPs, the invention is not so constrained. For example, packet analyzers and/or C&Rs may be deployed within any of a variety of network components, including, but not limited to terminal devices, set-top-boxes, modems, video recorders, network switches, gateways, routers, bridges, firewalls, or the like. In one embodiment, packet analyzer 114 and/or C&R 116 may reside within a Layer Service Provider (LSP) such as within a network stack of one of more computing devices, including a personal computer, or the like. One embodiment of a network device that may be employed to deploy a packet analyzer and/or a C&R is described in more detail below in conjunction with FIG. 4.

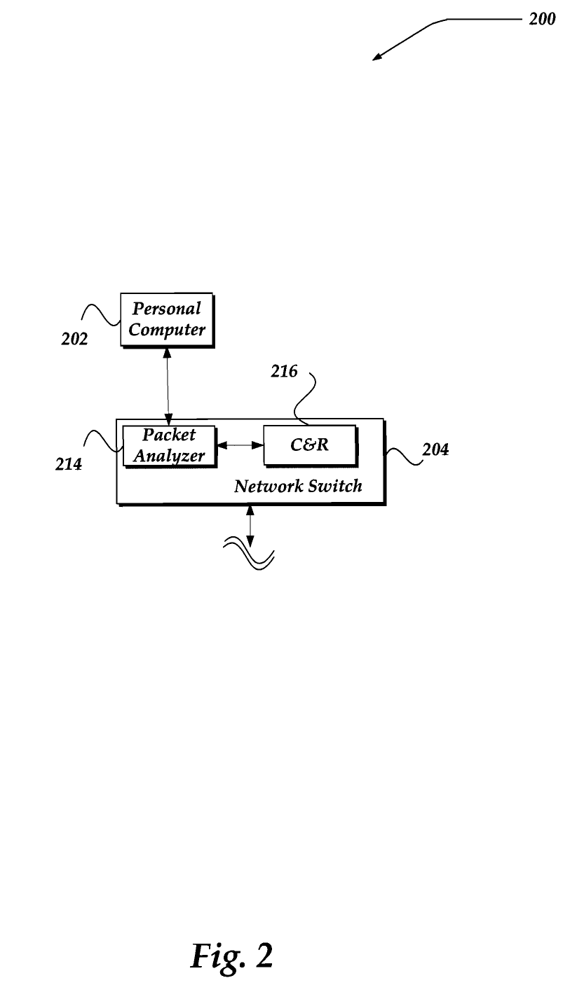

In addition, FIG. 2 shows a block diagram that illustrates one embodiment of a terminal device configuration having a packet analyzer and a C&R within a network switch. As shown in the figure, configuration 200 may represent components of terminal device 102 and/or 103 of FIG. 1. Configuration 200 may include many more components than those shown. The components shown, however, are sufficient to disclose an illustrative embodiment for practicing the invention. As shown configuration 200 includes network switch 204 and personal computer 202. Clearly, personal computer 202 may also represent a set-top-box, video recorder, television, or any of the other terminal devices described above in conjunction with FIG. 1. Network switch 204, which includes packet analyzer 214 and C&R 216, may also reside within personal computer 202, without departing from the scope of the invention. Moreover, although illustrated as a network switch, network switch 204 may also represent a router, a hub, a gateway, or even a component within a layer service provider, or the like.

Packet analyzer 214 and C&R 216 operate substantially similar to packet analyzers 114-115 and C&R 1161-117, respectively, of FIG. 1. Moreover, one embodiment of packet analyzers and C&Rs is described in more detail below.

FIG. 3 shows a block diagram that illustrates one embodiment of components for practicing the invention. System 300 may include many more components than those shown. The components shown, however, are sufficient to disclose an illustrative embodiment for practicing the invention.

As shown, system 300 includes processors 302 and 304. Processor 304 may represent 2-N processors. System 300 also includes external systems 310, external system source 306, and external management system 308.

External system source 306 may represent any of a variety of computing devices, including terminal devices 102-103 of FIG. 1, a server device, or the like. Similarly, eternal systems 310 may also be any of a variety of computing devices, including terminal devices 102-103 of FIG. 1, a server device, or the like. In one embodiment, external system source 306 represents a source of packets that may be sent over a network. Typically, such packets are sent using TCP/IP, however, the invention is not so limited, and other networking communication protocols may also be employed. In any event, such packets may include any of a variety of content, including files, pictures, software, text, HTML documents, or the like. In one embodiment, the packets may include media content, some of which may be restricted from duplication, distribution, or the like.

In another embodiment, external system source 306 may represent a component within a device, such as a DVD device, a CD device, a memory device, or the like. Thus, external system source 306 is not constrained, and may represent virtually any source of content to be protected. Thus, external system source 306 may further provide, in one embodiment, the media content to be protected, in any of a variety of formats, other than a packet. Thus, the use of the term packets may also refer to any of a variety of media content data formats useable to communicate the media content from one computing component to another computing component.

In any event, a flow of packets may be intercepted by packet analyzer 114 shown to reside on processor 302. Processor 302 may be implemented within any of a variety of network devices and/or components, including, but not limited to, within external system source 306, a set-top-box, a modem, a network switch, a recorder, a gateway, a server, or the like. Moreover, processor 302 and processors 304 may reside within a same or different network device.

In any even, packet analyzer 302 may be configured to intercept packets transmitted over the network (or other communication medium). Packet analyzer 302 may then perform an analysis on the packet, including its contents, to determine whether the packet includes at least a portion of media content. Packet analyzer 302 may be configured to make such determination based on a variety of mechanisms, including a type of bit rate associated with the packet, a size of a file associated with the flow of packets, a header within the packets, whether the packets are being re-transmitted frequently, as well as characteristics of the content, including whether it is an MPEG format, wave files (*.wav), MP3 files (*.mpg3), liquid audio files, Real Audio files, QuickTime files, Vivo files, Real Video files, or other format indicating that the content is an audio file, video file, or other type of media content. In one embodiment, packet analyzer 302 may employ a decryption mechanism to decrypt the content to assist in making such determination. In any event, if packet analyzer 302 determines that the content is not media content, packet analyzer 302 may forward the packets towards external systems 310. However, if media content is detected in the flow of packets, the packets may be redirected to fingerprint comparator 314.

Fingerprint comparator 314 may be configured to determine a fingerprint associated with the received media content using any of a variety of mechanisms, including those discussed above. Moreover, in one embodiment, fingerprint comparator 314 may also determine a watermark for the received media content.

Fingerprint comparator 314 may be configured to employ other fingerprints/watermarks to then perform a comparison to determine whether a match between the determined fingerprint/watermark for the received media content matches at least a portion of at least one of plurality of other fingerprints/watermarks.

The other fingerprints/watermarks represent fingerprints and/or watermarks that are associated with media content that is determined to be copy protected. These fingerprints/watermarks may be received from a variety of sources, including, but not limited to receiving them through an in-band mechanism with the media content, receiving them out-of-band from the media content, or the like. In one embodiment, an owner, distributor, producer, law enforcement agency, or the like, that is associated with the media content, may distribute fingerprints/watermarks for use in detecting piracy. In one embodiment, a fingerprint/watermark may be determined from media content received at external system source 306 and forwarded to fingerprint/comparator 314 based on the media content being copy protected, or the like.

In one embodiment, the other fingerprints/watermarks may be stored in a data store such as fingerprint 320, or the like. However, the invention is not so limited, and the received fingerprints/watermarks may also be stored in a folder, file, temporary memory store, or the like.

In any case, if a match is found between at least one of the other fingerprints/watermarks and the determined fingerprint/watermark, then a variety of actions may result. For example, in one embodiment, various forensic evidence may be collected and provided to forensic store 318. Such forensic evidence may include a packet source address (or other source identifier), a packet destination address (or other destination identifier), a characteristic of the media content, including for example, a type of media content, a name, or other identifier of the media content, or the like. In one embodiment, a copy of the media content may also be provided to forensic store 318. In addition, time information may also be collected, including, for example, when the media content was received, or the like. It should be clear, however, the virtually any forensic information may be collected that enables tracing of the source and/or destination of the media content.

In one embodiment, a message may be sent to response engine 316 which is configured to perform any of a variety of piracy detection responses, including, blocking a network transmission of the media content to the destination identified in the network packet. However, response engine 316 may also be configured to perform a variety of other actions, including, providing a piracy alert message to external management system 308; embed into the packet, media content, or the like, information such as copy control information (CCI), or the like. In one embodiment, the CCI may be embedded using a watermark, Copy Generation Management System Analogue (CGMS-A), a vendor product specific identifier, such as by Macrovision® or the like.

Moreover, response engine 316 may also degrade a quality characteristic of the media content and then allow the degraded media content to be forwarded towards its destination. For example, in one embodiment, a resolution of the media content may be degraded, an audio signal may be degraded, a pixel count may be decreased, a number of frames may be removed, color media content may be converted to various gray tones, packets may be dropped, selectively corrupting packets, or any of a variety of other degradation actions may be performed.

In addition, response engine 316 may also be configured to embed one or more fingerprints and/or watermarks into the media content. In one embodiment, the modified media content may then be forwarded towards its destination. The embedded fingerprints/watermarks may be visible to the ‘naked eye,’ or hidden. In one embodiment, one or more of the fingerprints/watermarks may include at least some of the collected forensic information. In another embodiment, response engine 316 may embed into the packet, media content, or the like, information such as copy control information (CCI), or the like. In one embodiment, the CCI may be embedded using a watermark, Copy Generation Management System Analogue (CGMS-A), a vendor product specific identifier, such as by Macrovision® or the like.

However, if response engine 316 determines that no match is found between the determined fingerprint/watermark and other fingerprints/watermarks, then response engine 316 may enable the network packets to continue towards their destination.

Packet analyzer 114, fingerprint comparator 314, and response engine 316 may each be configured to operate in real-time. That is, as packets are received from the network, analysis, comparison, and/or various responses may be performed virtually on-the-fly, rather than storing and performing such actions after the packet is forwarded, or holding the packet for an extended period of time.

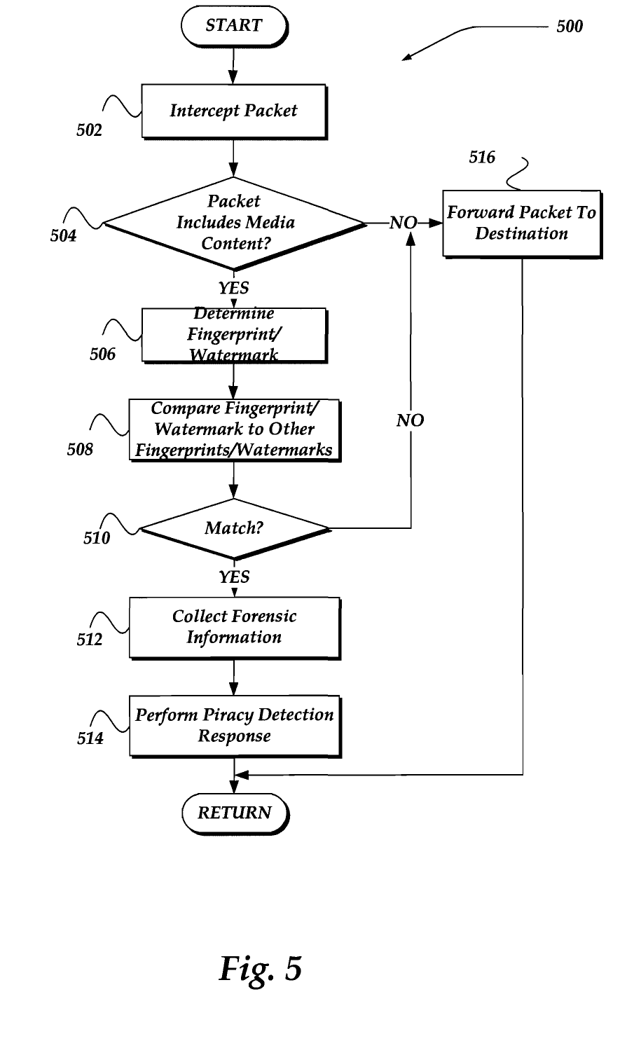

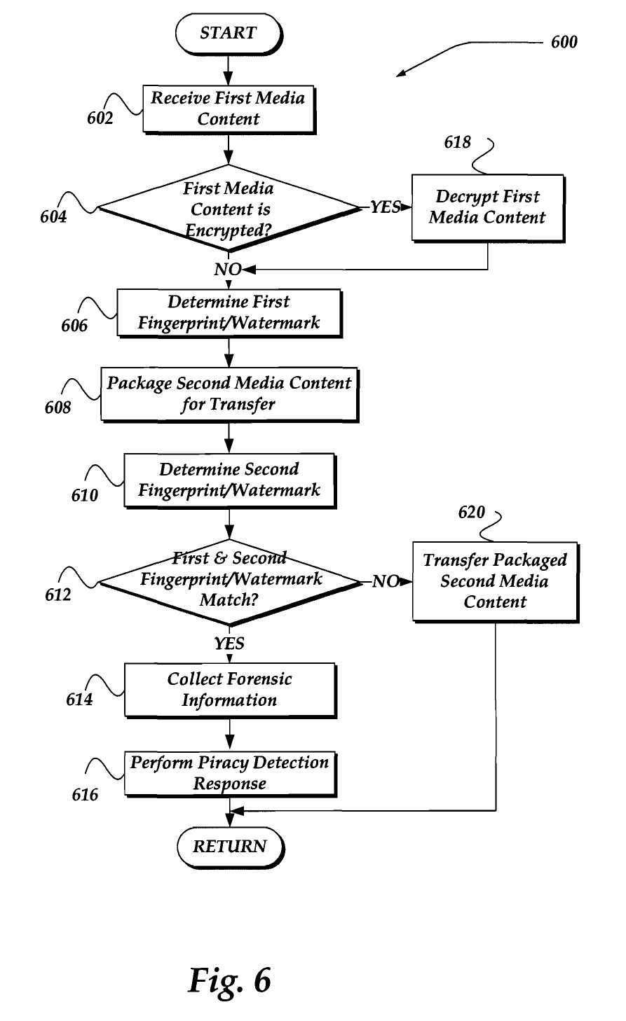

Moreover, packet analyzer 114, fingerprint comparator 314, and response engine 316 may employ processes substantially similar to those described below in conjunction with FIGS. 5-6 to perform at least some of its actions.

Illustrative Network Device

FIG. 4 shows one embodiment of a network device, according to one embodiment of the invention. Network device 400 may include many more components than those shown. The components shown, however, are sufficient to disclose an illustrative embodiment for practicing the invention. Network device 400 may be employed to implement packet analyzer 114 and C&R 116 (or packet analyzer 115 and C&R 117) of FIG. 1.

Network device 400 includes processing unit 412, video display adapter 414, and a mass memory, all in communication with each other via bus 422. The mass memory generally includes RAM 416, ROM 432, and one or more permanent mass storage devices, such as hard disk drive 428, tape drive, optical drive, and/or floppy disk drive. The mass memory stores operating system 420 for controlling the operation of network device 400. Any general-purpose operating system may be employed. Basic input/output system (“BIOS”) 418 is also provided for controlling the low-level operation of network device 400. As illustrated in FIG. 4, network device 400 also can communicate with the Internet, or some other communications network, such as networks in FIG. 1, via network interface unit 410, which is constructed for use with various communication protocols including the TCP/IP protocols. For example, in one embodiment, network interface unit 2410 may employ a hybrid communication scheme using both TCP and IP multicast with a terminal device, such as terminal devices 102-103 of FIG. 1. Network interface unit 210 is sometimes known as a transceiver, network interface card (NIC), and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 450 are loaded into mass memory and run on operating system 420. Examples of application programs may include transcoders, schedulers, graphics programs, database programs, word processing programs, HTTP programs, user interface programs, various security programs, and so forth. Mass storage may further include applications such as packet analyzer 452 and C&R 454. Packet analyzer 452 and C&R 454 operate substantially similar to packet analyzers, and C&Rs of FIGS. 1-3.

Generalized Operation

The operation of certain aspects of the invention will now be described with respect to FIG. 5-6. FIG. 5 illustrates a flow diagram generally showing one embodiment of a process of managing real-time copy detection.

As shown, process 500 of FIG. 1 begins, after a start block, at block 502, where a packet, or flow of packets, or other media content format is intercepted. Because of how content may be decomposed and packaged to be transmitted, it may take more than one packet to make a determination. In any event, processing moves next to decision block 504, where a determination is made whether the contents of the intercepted packet(s) is determined to be media content. If it is, processing moves to block 506; otherwise, processing flows to block 516, where the intercepted packet(s) are forwarded towards their destination. Processing then may return to a calling process to perform other actions.

At block 506, a fingerprint and/or watermark is determined for the intercepted media content, using any of a variety of techniques described above. Process 500 then continues to block 508, where the determined fingerprint/watermark is compared to other fingerprints/watermarks that are associated with copy protected media content. Processing continues to decision block 510, where a determination is made based on whether a match is found. Matches may be determined based on an exact match, or based on a match of at least a portion of the fingerprint/watermark. In one embodiment, a match may be based on a statistical confidence limit. That is, a comparison may be made that determines that the fingerprint/watermark matches another fingerprint/watermark within a given level of statistical confidence. In any event, if it is determined that a match is found, processing flows to block 512; otherwise, processing loops to block 516, where the intercepted packet(s) are forwarded towards their destination, and process 500 may return to the calling process.

At block 512, various forensic information such as described above may be collected. In one embodiment, the collected forensic information is stored. In another embodiment, at least some of the forensic information may be provided to an external management system, or the like, to indicate that piracy is being attempted. Processing then flows to block 514, where any one or more of a variety of piracy detection responses may be performed, including those described above. Process 500 then returns to the calling process.

FIG. 6 illustrates a flow diagram generally showing another embodiment of a process of managing real-time copy detection. In one embodiment, process 600 of FIG. 6 may represent a mechanism for managing updates to other fingerprints/watermarks that are used to detect piracy. Moreover, process 600 may also be employed to create fingerprints/watermarks on the fly for use in detecting attempts to improperly distribute media content.

As shown, process 600 begins, after a start block, at block 602, where a first media content is received. The first media content may be received from within a network packet, from a DVD, CD, or other storage medium, or the like. In any event, the first media content the first media content may be identified as being copy protected by any form of Digital Rights Management mechanism, and/or Conditional Access System (CAS). In one embodiment, the first media content is identified as being copy protected based on a ‘Broadcast flag,” or the like, such as that described by the FCC's Digital Broadcast Content Protection Report and Order (FCC-04-193).

Processing then flows to decision block 604, where a determination is made whether the first media content is at least partly encrypted. If so, processing flows to block 618 where the first media content is decrypted. Processing then flows to block 606. If the first media content is not encrypted, then processing also flows to block 606.

At block 606, a first fingerprint/watermark is determined based in part on the first media content. The first fingerprint/watermark may be determined based on any of a variety of mechanisms, including those described above. In one embodiment, the first fingerprint/watermark may have been associated with the first media content upstream in a market stream, at a studio, producer site, a head-end process location, or the like. In one embodiment, the first fingerprint/watermark is embedded within the first media content. In another embodiment, the first fingerprint/watermark is transmitted in-band with the media content such as through a PES, in an EMM, or the like. Moreover, in one embodiment, the first fingerprint/watermark is stored in a data store. However, the first fingerprint/watermark may also be saved in temporary memory rather than a long term storage mechanism.

Processing then flows to block 608 where a second media content may be received and/or prepared to be transmitted over a network, or otherwise distributed. In one embodiment, the second media content may be provided to a program, application, operating system component, or the like, for packaging it for network distribution. In any event, when it is determined that the second media content is being ‘readied’ for distribution, a second fingerprint/watermark is determined for the second media content using any of the above mechanisms.

Processing then flows to decision block 612, where a comparison is performed between the first and the second fingerprint/watermark to determine whether they match. A match indicates that the second media content may be a copy of the first media content. Recall that the first media content is identified as copy protected. Thus, a match indicates that an attempt is being made to distribute copy protected media content. Thus, if a match is made, processing flows to block 614; otherwise, no match is found and processing flows to block 620. At block 620, it is determined that the second media content may not be copy protected, and thus, it is allowed to be transferred to a destination. Processing then returns to a calling process.

However, if a match is found, processing continued to block 614, where in one embodiment, forensic information may be collected, such as described above. Processing continues next to block 616, where any of a variety of piracy detection actions may be performed. For example, in one embodiment, it may be determined that the first media content may be distributed, but it is to be distributed as at least selectively encrypted media content. Thus, in one embodiment, a possible piracy detection action may be to selectively encrypt the second media content before it is allowed to be distributed.

Other possible actions, however, may include, blocking distribution of the second media content, degrading a quality of the media content, deleting the second media content, and perhaps deleting the first media content, associating one or more fingerprints and/or watermarks with the second media content, or the like. In any event, in one embodiment, similar actions may also be performed on the first media content—which is the original media content received. Upon completion of block 616, processing may return to the calling process.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause operational steps to be performed by the processor to produce a computer implemented process such that the instructions, which execute on the processor to provide steps for implementing the actions specified in the flowchart block or blocks. In one embodiment, at least some of the operational steps may be performed serially; however, the invention is not so limited, and at least some steps may be performed concurrently.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the embodiments of the invention. However, many other embodiments of the invention can be made without departing from the spirit and scope of the invention.

We claim:

1. A processor readable medium having computer-executable instructions, wherein the execution of the computer-executable instructions provides for copy protection of media content by enabling actions, including:
intercepting a packet and
determining if the packet comprises media content, and if the packet comprises media content, then:
determining a fingerprint from the media content, and
if the determined fingerprint indicates that piracy is being attempted, then collecting forensic information associated with the packet, and initiating a piracy detection response.

2. The processor readable medium of claim 1, wherein determining if the packet comprises media content further comprises making a determination based, in part, on at least one of the following: a type of bit rate associated with the packet, a protocol type, a media format, a size of the media content associated with the packet, or a pattern of packet re-transmissions.

3. The processor readable medium of claim 1, wherein the action of “if the determined fingerprint indicates that piracy is being attempted” further comprises at least one of receiving a comparison fingerprint through a mechanism out of band from receiving of the packet, or receiving the comparison fingerprint in-band with the media content.

4. The processor readable medium of claim 1, wherein the piracy detection response comprises at least one of blocking transmission of the media content over the network, degrading a quality of the media content, embedding copy control information in the media content, or providing a piracy alert.

5. The processor readable medium of claim 1, wherein the action of “if the determined fingerprint indicates that piracy is being attempted” further comprises performing a comparison between the determined fingerprint from the media content with other fingerprints, wherein the other fingerprints are associated with copy-protected media content.

6. The processor readable medium of claim 1, wherein the piracy detection response comprises including at least one of a watermark, a fingerprint, or forensic information within the media content.

7. The processor readable medium of claim 6, wherein initiating a piracy detection response further comprises:
modifying the media content by hiding the forensic information within the media content, or hiding other copy control information within the media content; and
providing the modified media content to a destination address determined from the intercepted packet.

8. The processor readable medium of claim 1, wherein collecting forensic information further comprises determining a source of the packet associated with the media content, or a destination for the intercepted packet.

9. A modulated data signal configured to include the computer-executable instructions for performing the actions of claim 1.

10. A network device for managing copy protection of media content, comprising:
a transceiver to send and receive data over a network; and
at least one processor that is operative to perform actions, including:
receiving a first media content at the network device;
determining a first fingerprint associated with the first media content;
packaging a second media content into at least one network packet for distribution;
determining a second fingerprint associated with the second media content; and
if the first fingerprint matches the second fingerprint, ensuring that the second media content is encrypted if distributed.

11. The network device of claim 10, wherein packaging the second media content further comprises including within the packaged second media content at least one of a watermark, or forensic information associated with the second media content.

12. The network device of claim 10, wherein packaging the second media content further comprises degrading a quality of the second media content.

13. The network device of claim 10, wherein if the first fingerprint matches the second fingerprint, indicating that the second media content is an unauthorized copy of the first media content, further comprising initiating a piracy detection response that includes at least one of sending a piracy notification, or blocking transmission of the second media content over the network.

14. The network device of claim 10, wherein determining the first or the second fingerprint further comprises determining the fingerprint based on a characteristic of the media content.

15. A system for detecting copying of media content, comprising:
a first processor that is operative to perform actions, including:
receiving a packet;
analyzing on-the-fly the packet to determine if it is comprises media content,
if the packet does comprise media content, redirecting the packet to a second processor;
if the packet does not comprise media content, enabling the packet to be routed to a specified destination; and
the second processor being operative to perform actions, including:
receiving the packet comprising media content;
determining a fingerprint associated with the media content; and
determining on-the-fly if the determined fingerprint matches a fingerprint associated with protected content, and if it does match, then:
determining forensic information associated with the packet; and
performing at least one piracy detection response.

16. The system of claim 15, wherein the actions of the second processor further comprises:
receiving the fingerprint associated with protected content from at least one of in-band with the received packet comprising media content or from another processor.

17. The system of claim 15, wherein performing at least one piracy detection response further comprises performing at least one of sending a piracy alert, modifying the media content with forensic information, modifying the media content to degrade a quality characteristic, blocking transmission of the media content, selectively encrypting at least a portion of the media content, or modifying the media content with at least one of a fingerprint or a watermark.

18. The system of claim 15, wherein at least the first processor resides within at least one of a set-top-box, a personal video recorder, a personal computing device, or a switch.

19. The system of claim 15, wherein the second processor is operative to perform actions, further including:
if the determined fingerprint is determined to not match a fingerprint associated with protected content, enabling the packet to be transmitted to the specified destination.

20. An apparatus for managing copy protection of media content, comprising:
a transceiver to send and receive data;
means for determining on the fly whether a packet includes media content;
means for generating on the fly a fingerprint or watermark from the media content;
means for determining on the fly whether the media content is being pirated based, in part, on a comparison between the generated fingerprint or watermark and another fingerprint or another watermark; and
means for enabling a piracy detection response and forensic information collection, if it is determined that the media content is being pirated.
